(19) United States
(12) Patent Application Publication
(10) Pub. No.: US 2025/0071180 A1
(43) Pub. Date: Feb. 27, 2025

(54) PROFILE-BASED ASSOCIATION METHOD FOR ENTERPRISE NETWORKS

(71) Applicant: Cisco Technology, Inc., San Jose, CA (US)

(72) Inventors: Jerome Henry, Pittsboro, NC (US); Bart A. Brinckman, Nevele (BE); Vincent E. Parla, New Hampton, NH (US); Srinath Gundavelli, San Jose, CA (US); Shree N. Murthy, San Jose, CA (US); Matthew S. MacPherson, Research Triangle Park, NC (US)

(73) Assignee: Cisco Technology, Inc., San Jose, CA (US)

(21) Appl. No.: 18/816,911

(22) Filed: Aug. 27, 2024

Related U.S. Application Data
(60) Provisional application No. 63/579,021, filed on Aug. 27, 2023.

(51) Int. Cl. H04L 67/306; H04L 67/14

(52) U.S. Cl. CPC H04L 67/306; H04L 67/14

(57) ABSTRACT

Profile-based association method for enterprise networks may be provided. A computing device may configure a first profile and a second profile. Next, the client device may be configured with a set of network profiles associated with a plurality of networks. A user of the client device may be queried for a profile choice for one of the plurality of networks. Then the client device may associate with the one of the plurality of networks according to the profile choice provide by the user.

### RELATED APPLICATION TECHNICAL FIELD

Under provisions of 35 U.S.C. § 119 (e), Applicant claims the benefit of U.S. Provisional Application No. 63/579,021 filed Aug. 27, 2023, which is incorporated herein by reference.

### TECHNICAL FIELD

The present disclosure relates generally to providing profile-based association method for enterprise networks.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing profile-based association method for enterprise networks;

FIG. 2 is a flow chart of a method for providing profile-based association method for enterprise networks;

FIG. 3 is a block diagram of a computing device;

FIG. 4 illustrates a system for allocation and binding of traffic coloring tags and identifiers with mobile device profiles;

FIG. 5 is a flow diagram of a method for allocation and binding of traffic coloring tags and identifiers with mobile device profiles; and

FIG. 6 is a flow diagram of a method for allocation and binding of traffic coloring tags and identifiers with mobile device profiles.

### DETAILED DESCRIPTION

### Overview

Profile-based association method for enterprise networks may be provided. A computing device may configure a first profile and a second profile. Next, the client device may be configured with a set of network profiles associated with a plurality of networks. A user of the client device may be queried for a profile choice for one of the plurality of networks. Then the client device may associate with the one of the plurality of networks according to the profile choice provide by the user.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In enterprise networks, people access professional resources as well as personal resources from their work devices (e.g., computers, tablets, phones, etc.). This behavior is true while on campus or on the go.

The treatment for both types of traffic should be different. On campus, work traffic should go into the corporate network mix, and be policed (e.g., security, Quality-of-Service (QOS), etc.). However, personal traffic should not be examined or policed or mixed with the work traffic. This may be for security reasons, and because in some regulatory domains, examining personal traffic, for policing or other may be considered privacy violation. While on the go, personal traffic may go directly to the Internet. Work traffic, however, may be protected and possibly sent to a Cloud service (e.g., for policing) or to the corporate network. Additionally, personal traffic may receive basic public Wi-Fi treatment, while work traffic may benefit from some premium tier (e.g., better bandwidth, for a fee). However, in conventional systems, all traffic from a given device looks alike, and it may be difficult to distinguish personal from work traffic, without DPI (which then may violate privacy). Accordingly, there may be a need to allow a client service (e.g., a station (STA)) and the network to differentiate between personal and work traffic and apply differentiated treatment.

Embodiments of the disclosure may differentiate a personal profile verses a work profile coming from a single client device. This differentiation may allow the infrastructure to apply differentiated policies. For example, in campus, treat personal traffic as Personally Identifiable Information (PII) and untrusted, treat work traffic as accepted on the corporate Local Area Network (LAN), and in guest networks treat personal traffic as best effort while work traffic may be affected premium (but chargeable) treatment.

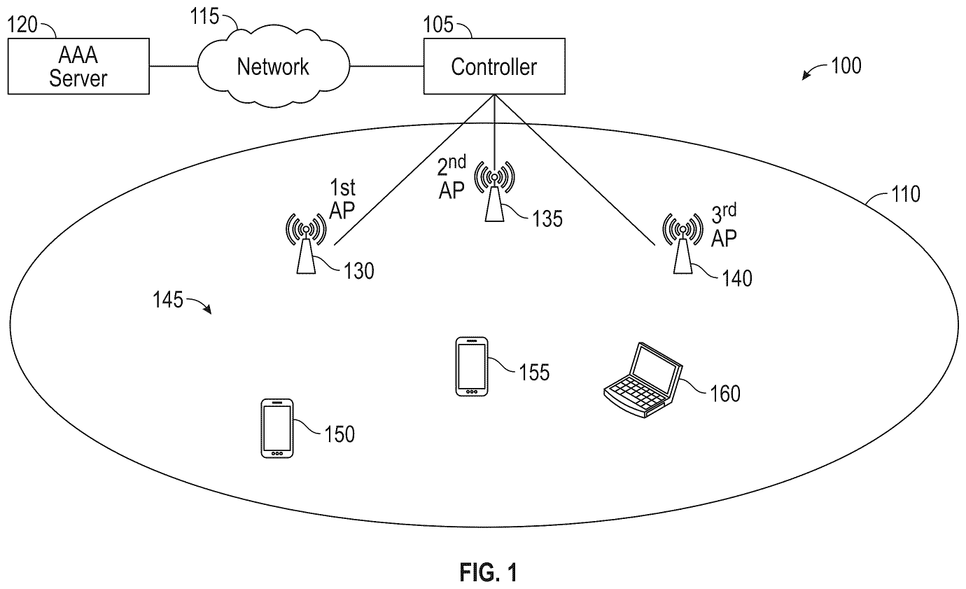

FIG. 1 shows an operating environment 100 for providing profile-based association method for enterprise networks. As shown in FIG. 1, operating environment 100 may comprise a controller 105, a coverage environment 110, a network 115, and an Authentication, Authorization, and Accounting (AAA) server 120 (e.g., an identity provider). Coverage environment 110 may comprise, but is not limited to, a Wireless Local Area Network (WLAN) comprising a plurality of Access Points (APs) that may provide wireless network access (e.g., access to the WLAN) for devices. The plurality of APs may comprise a first AP 130, a second AP 135, and a third AP 140. AAA server 120 may provide network access and may use two types of packets to manage the full AAA process. One packet type may comprise Access-Request, which manages authentication and authorization. Another packet type may comprise Accounting-Request, which manages accounting. Each of the plurality of APs may be compatible with specification standards such as, but not limited to, the Institute of Electrical and Electronics Engineers (IEEE) 802.11 specification standard for example.

A plurality of devices 145 may be deployed in coverage environment 110. The plurality of APs may provide wireless network access to plurality of devices 145 as the devices move within coverage environment 110. Coverage environment 110 may comprise an outdoor or indoor wireless environment for Wi-Fi or any type of wireless protocol or standard.

Plurality of devices 145 may comprise a first client device 150, a second client device 155, and a third client device 160. Ones of plurality of devices 145 may comprise, but are not limited to, a smart phone, a personal computer, a tablet device, a mobile device, a telephone, a remote control device, a set-top box, a digital video recorder, an Internet-of-Things (IoT) device, a smart watch, a smart Television (TV), a wireless docking station, a network computer, a router, an AR/VR device, an Automated Transfer Vehicle (ATV), a drone, an Unmanned Aerial Vehicle (UAV), a smart wireless light bulb, or other similar microcomputer-based device.

Controller 105 may comprise a Wireless Local Area Network controller (WLC) and may provision and control coverage environment 110 (e.g., a WLAN). Controller 105 may allow plurality of client devices 145 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide profile-based association method for enterprise networks.

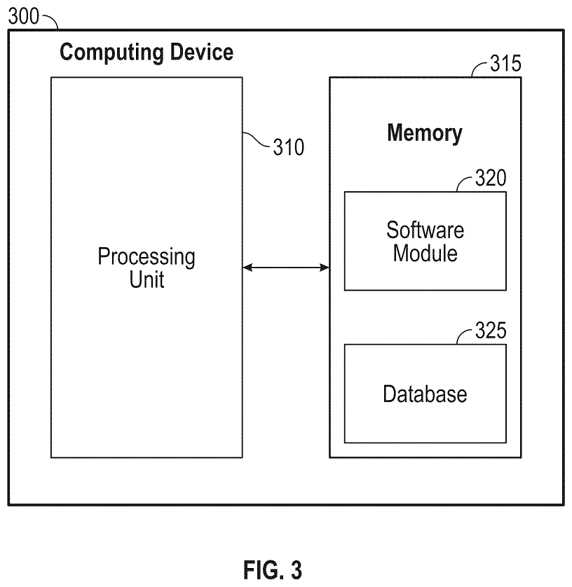

The elements described above of operating environment 100 (e.g., controller 105, AAA server 120, first AP 130, second AP 135, third AP 140, first client device 150, second client device 155, and third client device 160) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

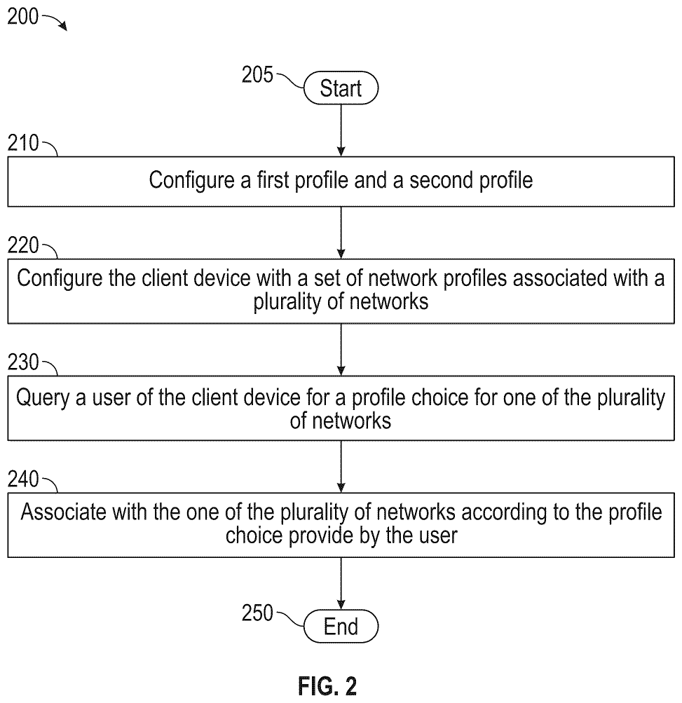

FIG. 2 is a flow chart setting forth the general stages involved in a method 200 consistent with embodiments of the disclosure for providing profile-based association method for enterprise networks. Method 200 may be implemented using computing device 300 as described in more detail below with respect to FIG. 3. Computing device 300 may be embodied by first client device 150. Ways to implement the stages of method 200 will be described in greater detail below.

Method 200 may begin at starting block 205 and proceed to stage 210 where first client device 150 may configure a first profile and a second profile. The first profile may comprise a work profile and the second profile may comprise a personal profile (and visa versa). For example, in an Operating System (OS), labels may be applied to each profile. In some OSs, each profile may comprise a container at or above the core OS. Each application may make network socket calls from within its container, and the core OS may validate the socket call before transmitting it down the networking stack. Thus the core OS may have awareness of the profile from which the socket call emanates. An application “A” may be installed only for one profile (work or personal), while an application “B” may be installed for both profiles (and be installed twice, partially, or entirely).

In other embodiments, the profiles may be applied at the application level. Thus application A may be installed on the OS and available for all profiles. A user profile for work may be activated for that application, and another user profile for personal traffic may also be activated. Thus the user, opening the application, may swipe from one profile to the other, access the profile-relevant content (e.g., list of personal or work emails in mailbox), and interact with the application from within the relevant profile. Thus, although the application may be common to all profiles, the user actions may be initiated from within a profile, and the application may have awareness that a socket call has relevance for one or another profile. Consequently, embodiments of the disclosure may allow an application making a socket call, or the OS receiving the socket call, to mark the call with a label indicating “work” (e.g., the first profile) or “personal” (e.g., the second profile).

From stage 210, where first client device 150 configures the first profile and the second profile, method 200 may advance to stage 220 where first client device 150 may be configured with a set of network profiles associated with a plurality of networks. For example, IEEE 802.1X networks that may be accessed daily may be labelled “work”, while Pre-Shared Key (PSK)-networks accessed daily and mostly in the evening may be labelled “personal”. Similarly, public hotspots and unknown networks may be labelled “personal”, etc . . .

Once first client device 150 is configured with the set of network profiles associated with the plurality of networks in stage 220, method 200 may continue to stage 230 where first client device 150 may query a user of first client device 150 for a profile choice for one of the plurality of networks. For example, a Wi-Fi network may be in range of first client device 150. In one embodiment, the user of first client device 150 may be queried for a connection sequence, for example, which profile(s) to use for association, work, personal, or both with a possible sequence (e.g., work first, then personal). The user's choice may be stored and reused by first client device 150 for a next connection, and that default may be set on first client device 150.

After first client device 150 queries the user of first client device 150 for the profile choice for one of the plurality of networks for a profile choice for one of the plurality of networks in stage 230, method 200 may proceed to stage 240 where first client device 150 may associate with the one of the plurality of networks according to the profile choice provide by the user. For example, in one embodiment, the network may be IEEE 802.1X and may use Remote Authentication Dial-In User Service (RADIUS) for authentication. In one embodiment, first client device 150 may use a different Media Access Control (MAC) address, and thus a different Called-Session-Id, to distinguish work from personal packets and frames. Thus, in that embodiment, first client device 150 may use one MAC address to authenticate to RADIUS using the work profile, and another MAC address to authenticate to RADIUS using the personal profile (possibly using the same user credentials in both cases). An additional RADIUS flag (e.g., Vendor Specific Attribute (VSA)) may indicate that the authentication matches the personal or the work profiles. In another embodiment, the network may comprise a public guest network, with Passpoint authentication or a portal. Association may proceed as described above. When both profiles associate, each profile matches a separate client device MAC address.

Consistent with embodiments of the disclosure, when differentiated services may be offered to the user (e.g., free vs. premium tiers), the user may be prompted with a choice (e.g., premium or not, and for which profile). For OSs isolating profiles from the OS layer, the user may be within a profile when opening a web browser. Thus the “premium or free” choice portal may open to the user from within the matching profile, and the user may choose to pay for premium for one, both, or neither profile contexts. In one embodiment, the user may choose to bundle both profiles (thus pay once for both). In that embodiment, first client device 150 may carry both profile's traffic from within a single MAC address. For OSs using common applications for both profiles, the application may overlay to the portal a profile choice (e.g., “do you want to see this page within the context of profile A, B, or both”). Operations may then proceed as above. In another embodiment, the network may be PSK-based. First client device 150 may still uses one MAC address per profile, and the User Interface (UI) may displays the MAC address used for each profile, so that the network administrator may configure MAC-specific policies if applicable.

In yet another embodiment, first client device 150 may use a single MAC address for both profiles. As described above, first client device 150 may use the VSA to identify a profile verses the other. As also described above, first client device 150 may use a single MAC address. Then, when packets are sent from first client device 150, first client device 150 may use a label to identify personal verses work traffic. In one embodiment, first client device 150 may register (to RADIUS for IEEE 802.1X networks, to the AP via a post-association management frame for PSK and Open/Web portal networks) the label used for work and the label used for personal traffic, when these labels are not standardized.

Consistent with embodiments of the disclosure, the infrastructure may be able to distinguish personal from work traffic, and apply differentiated policies, for example (campus case) sending all personal traffic to the DMZ, or (public Wi-Fi case) applying premium bandwidth to the work traffic. Additionally, in one embodiment, first client device 150 itself may apply differentiated policies. For example, work traffic may be sent through a Virtual Private Network (VPN) or to a Cloud security gateway first (public Wi-Fi case) while the personal traffic may be sent to the AP and its supporting network. Once first client device 150 associates with the one of the plurality of networks according to the profile choice provide by the user in stage 240, method 200 may then end at stage 250.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing profile-based association method for enterprise networks as described above with respect to FIG. 2. Computing device 300, for example, may provide an operating environment for controller 105, AAA server 120, first AP 130, second AP 135, third AP 140, first client device 150, second client device 155, and third client device 160. Controller 105, AAA server 120, first AP 130, second AP 135, third AP 140, first client device 150, second client device 155, and third client device 160 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples and computing device 300 may comprise other systems or devices.

Mobile device profiles may be configurations that enable users to segment their mobile usage into distinct compartments based on the purpose. Two types of profiles may comprise enterprise profile (e.g., work) and personal profile.

An enterprise profile may be designed to compartmentalize work-related tasks and communications. This profile may contain business-specific applications, email accounts, productivity tools and access policies. By this separation, users may maintain a clear boundary between professional and personal activities.

On the other hand, a personal profile may be solely dedicated to personal communication, entertainment, and applications. This profile may include personal email accounts, social media applications, banking applications, utility applications, and gaming applications. Having a personal profile may allow users to enjoy their device for recreational purposes without mixing it with work-related tasks.

Having distinct profiles offers a range of benefits. For example, it may streamline access to relevant applications and information, ensure that work-related activities do not interfere with personal activities. Users may easily switch between profiles, enabling them to transition between enterprise and personal modes seamlessly. This separation may be important for maintaining privacy and security. Moreover, it may facilitate network operators in complying with privacy regulations concerning the exposure of personal user information.

Device vendors may support profile-management tools in their operating systems. While there may be semantics in the client for profile creation, switching and management, but there may be no semantics for signaling the same to the network.

In the absence of such signaling, networks may not know the profile associated with a given IEEE 802.11 association/connection, or with each of the IP flows associated to that connection. More specifically, there may be no distinct markers either in the IEEE 802.11 signaling, layer-2 or layer-3 client identifiers. When such markers are present, it is possible to distinguish traffic based on the profile and provide differentiated treatment. This may be important for the teleworker use-cases, where the remote enterprise access point should have visibility for making the decision as if a given flow needs to be tunneled back to the enterprise, or needs to be offloaded locally.

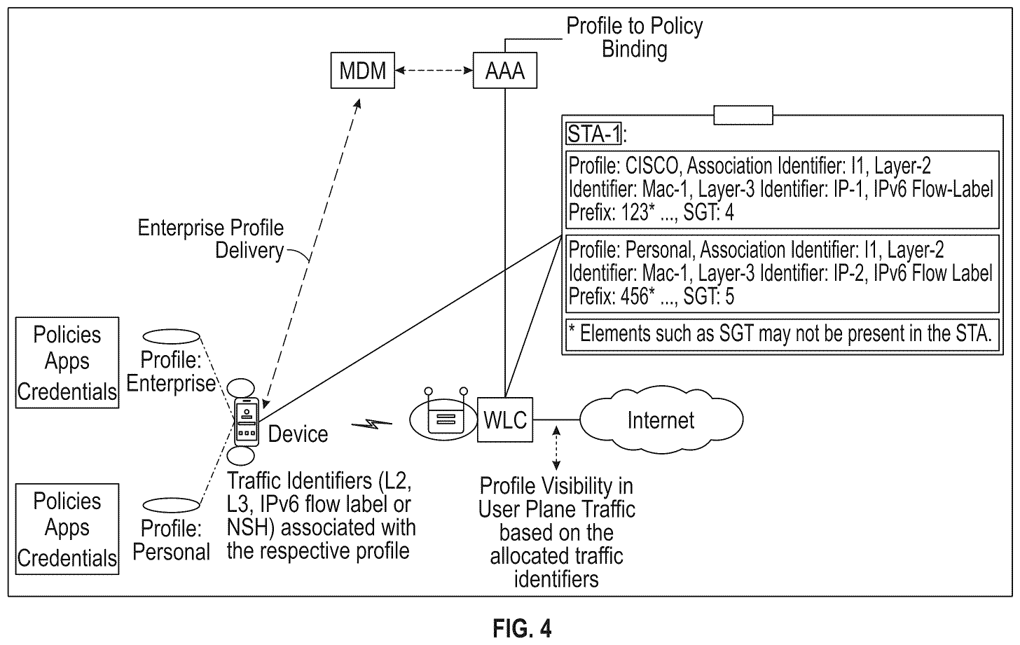

As illustrated by FIG. 4, the enterprise profile delivered to the device from the network may include a profile tag (e.g., an identifier for the enterprise profile). Enterprise policy system such as AAA may bind this profile-tag to a set of enterprise policies.

### Single Association

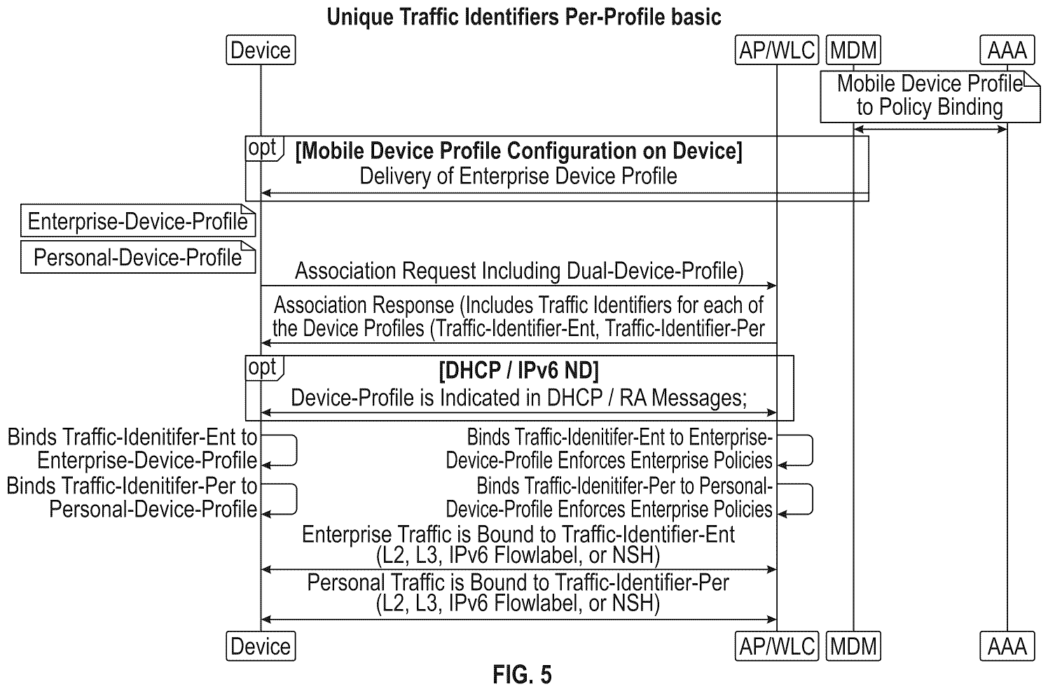

FIG. 5 illustrates single associations. The network allocates/marks different set of traffic identifiers that the device may use for traffic associated with different mobile device profiles. However, the session may not bound to any single profile, but may be marked for use across multiple profiles. In other words, the disambiguation is not at the session level, but based on marking at the flow level.

The unique traffic identifiers associated with each profile may include layer-2 identifiers (e.g., MAC address), IPv4/IPv6 address, IPv6 flow label prefix and/or Network Service Header (NSH) type value.

A set of identifiers for enterprise profile and another set of identifiers for private profile, may allow the device to use different identifiers for traffic associated with different profiles. It may also allow the network to distinguish the traffic based on these traffic identifiers.

### Dual Association

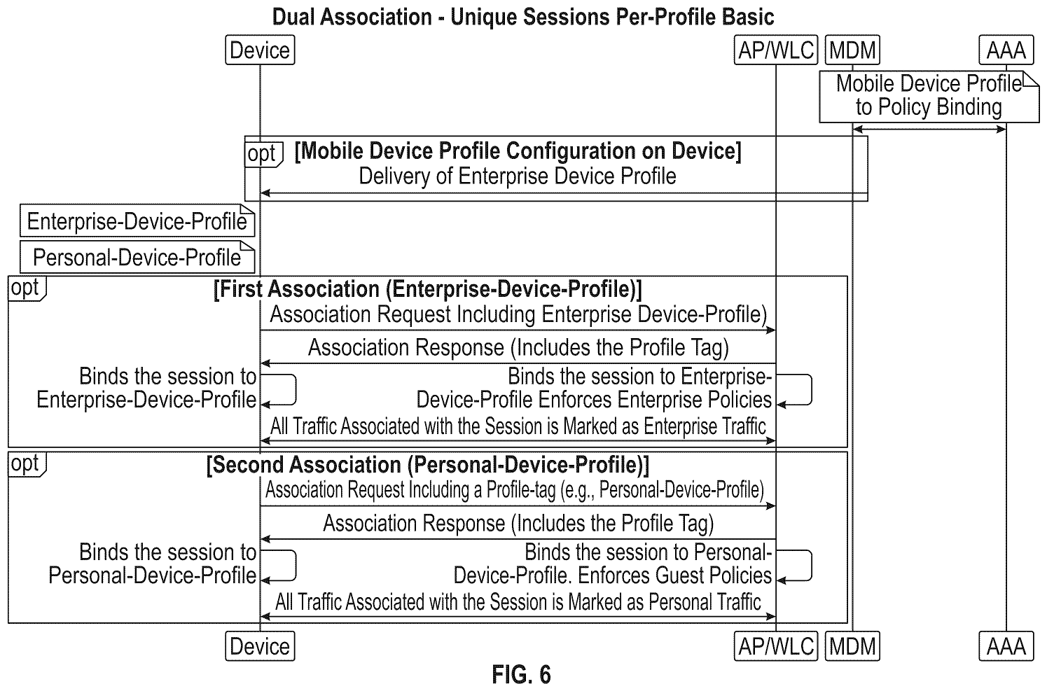

FIG. 6 illustrates dual associations. The device may signal the profile tag to the network. The indication may be in the form of including the profile tag in the 802.11 signaling. When such profile tag is present in the IEEE 802.11 association request, the resulting Wi-Fi association/session may be marked to be for enterprise use.

All the traffic using that session may be subjected to enterprise policies associated with that enterprise profile. A client performing dual association may mark one of the associations as intended for enterprise-use and the other for personal use. The network disambiguates traffic based on the connection and apply the respective policies.

Embodiments of the disclosure may deliver mobile device profiles over Mobile Device Management (MDM) device interface. For example, embodiments of the disclosure may allow a device to indicate mobile device profile tag in IEEE 802.11 signaling to the network. The profile tag may be indicative of the intended purpose of use of that IEEE 802.11 association. Embodiments of the disclosure may allow device and network marking that session for exclusive use of application traffic associated with that profile, the network enforcing the respective policies. These policies may include making a forwarding decision such as tunneling the packet to the enterprise network, or locally offloading it.

Embodiments of the disclosure may provide traffic identifier allocation over IEEE 802.11 signaling. These identifiers may be a specific layer-2 address, a specific IPv4 address, a specific IPV6 prefix, a specific IPV6 flow label prefix (first few bits of the IPV6 flow label), and/or a specific Network Service Header (NSH) with a distinct type value.

Embodiments of the disclosure may provide for the inclusion of mobile device profile tag in Dynamic Host Configuration Protocol (DHCP) signaling (e.g., option 82). Embodiments of the disclosure may also provide for the inclusion of mobile device profile IPv6 Router advertisement. Also, embodiments of the disclosure may also provide for the network delivering a NSH service header on a profile basis. The device may use the allocated service header with application traffic associated with that profile.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
configuring, on a client device, a first profile and a second profile;
configuring the client device with a set of network profiles associated with a plurality of networks;
querying a user of the client device for a profile choice for one of the plurality of networks; and
associating with the one of the plurality of networks according to the profile choice provide by the user.

2. The method of claim 1, wherein the first profile is a personal profile.

3. The method of claim 1, wherein the second profile is a work profile.

4. The method of claim 1, wherein the profile choice comprises at least one of the first profile, the second profile, both the first profile and the second profile, and a sequence.

5. The method of claim 1, further comprising distinguishing between the first profile and the second profile based on a called-Session-ID.

6. The method of claim 1, further comprising distinguishing between the first profile and the second profile based on a Vendor Specific Attribute (VSA).

7. The method of claim 1, further comprising marking a plurality of socket calls as being associated with one of the first profile and the second profile.

8. The method of claim 7, wherein marking the plurality of socket calls comprises marking the plurality of socket calls based on a container associated with one of the first profile and the second profile.

9. The method of claim 7, wherein marking the plurality of socket calls comprises marking the plurality of socket calls based on an application associated with one of the first profile and the second profile.

10. A system comprising:
a memory storage; and
a processing unit disposed on a client device and coupled to the memory storage, wherein the processing unit is operative to:
configure a first profile and a second profile;
configure the client device with a set of network profiles associated with a plurality of networks;
query a user of the client device for a profile choice for one of the plurality of networks; and
associate with the one of the plurality of networks according to the profile choice provide by the user.

11. The system of claim 10, wherein the first profile is a personal profile.

12. The system of claim 10, wherein the second profile is a work profile.

13. The system of claim 10, wherein the profile choice comprises at least one of the first profile, the second profile, both the first profile and the second profile, and a sequence.

14. A non-transitory computer-readable medium that stores a set of instructions which when executed perform a method executed by the set of instructions comprising:
configuring, on a client device, a first profile and a second profile;
configuring the client device with a set of network profiles associated with a plurality of networks;
querying a user of the client device for a profile choice for one of the plurality of networks; and
associating with the one of the plurality of networks according to the profile choice provide by the user.

15. The non-transitory computer-readable medium of claim 14, wherein the first profile is a personal profile.

16. The non-transitory computer-readable medium of claim 14, wherein the second profile is a work profile.

17. The non-transitory computer-readable medium of claim 14, wherein the profile choice comprises at least one of the first profile, the second profile, both the first profile and the second profile, and a sequence.

18. The non-transitory computer-readable medium of claim 14, further comprising distinguishing between the first profile and the second profile based on a called-Session-ID.

19. The non-transitory computer-readable medium of claim 14, further comprising distinguishing between the first profile and the second profile based on a Vendor Specific Attribute (VSA).

20. The non-transitory computer-readable medium of claim 14, further comprising marking a plurality of socket calls as being associated with one of the first profile and the second profile.
